(19) United States
(12) Patent Application Publication
(10) Pub. No.: US 2006/0273195 A1
(43) Pub. Date: Dec. 7, 2006

(54) Portable misting fan with closely integrated pump

(76) Inventor: Eric Junkel, Des Plaines, IL (US)

Correspondence Address: GIFFORD, KRASS, GROH, SPRINKLE & CITKOWSKI, P.C, PO BOX 7021, TROY, MI, 48007-7021, US

(21) Appl. No.: 11/144,337

(22) Filed: Jun. 3, 2005

(51) Int. Cl. B05B 3/02; F02M 47/02; A62C 11/00; B01D 47/00; B67D 1/07

(52) U.S. Cl. 239/222.11; 239/289; 239/333; 261/28; 239/89; 222/192; 222/321.9

(57) ABSTRACT

A portable misting fan having a compact and three-dimensional body. An impeller includes a plurality of rotatable fan blades mounted to the body. An elongated and linearly actuating pump is incorporated into the body. A first end of the pump cylinder defines an inlet in communication with a fluid reservoir. A second end of the pump cylinder defines an exposed orifice in communication with a path of rotation associated with the fan blades, the orifice mounting to a discharge portion axially displaceable relative to an intermediate cylinder portion of the pump. A trigger is pivotally secured to the body, a portion of the trigger including a cam surface arranged in opposing and coacting fashion relative to a cam surface associated with the orifice. Upon depressing the trigger, the discharge tube is caused to displace inwardly relative to the cylinder portion, a spray mist issuing from the orifice and into a path associated with the rotating fan blades.

### BACKGROUND OF THE INVENTION

1. Field of the Invention

The present invention relates generally to portable fans and fluid misting pump assemblies. More specifically, the present invention discloses a portable misting fan assembly in which a pump cylinder associated with the sprayer is positioned close to the motor and such that an associated center axis is parallel to the motor shaft axis.

2. Description of the Prior Art

Personal misting devices, either including or without a fan, are known in the art. In each instance, a fine mist of water is ejected into the air, the evaporation of the water droplets cooling the air surrounding the droplets. An electrical motor driven fan propels the cooled air stream and mist in a direction towards a user.

Portable misting fan devices of such design have been known for several years in the prior art, these typically employing a battery operated fan atop a trigger spray bottle. A pump sprayer is attached to a neck of the bottle and, when used in combination with the fan, enhances the evaporative and cooling effect of the issued spray mist. It is also known that the water reservoir associated with the sprayer can also be used for drinking, however limited water reservoir capacity and sanitation issues (e.g. spraying saliva-tainted water) has limited the use of misting fans with drinking nipples.

Portable misting fans typically also require a pump device to move water from the low pressure reservoir through the atomizing orifice. The pump is typically manually operated and one pull of the trigger (or push of a button) sprays a fixed volume of water, and whereas repeated pulls create additional spray.

A battery-operated DC motor drives a plurality of rotatably mounted fan blades. Assuming the fan blade is positioned downstream of the atomizing spray nozzle, the evaporative cooling of the moisture is enhanced, as is the evaporation of the moisture from the user's skin. Commercially available portable misting fans typically use off-the-shelf sprayers for dispensing household chemicals (e.g. window cleaner) and cosmetics/toiletries (e.g. hairspray).

Other existing misting fans also attach to the reservoir using a screw thread connection. The sprayers come with these threaded closures and a sealing gasket as a standard feature. Some have used alternate means to attach the sprayer to the bottle that prevent the sprayer from being removed. In instances where the sprayer is permanently affixed to the bottle, a secondary port is required for easy filling.

Problems associated with the existing art involve the commercially available misting fans relying on off-the-shelf sprayers to operate, and such that the configurations of their fan heads are limited by the geometry and strength of the sprayer. These tend to be unsatisfactory for attachment of a fan head with motor, switch and batteries.

The present art further tends to be deficient in that the pumps associated with the misting fans are not well-integrated with the fan enclosure. Mechanically, they are shaped for stand-alone operation atop a bottle, not to be integrated within the fan enclosure. Typically such devices further lack the interfaces for attaching the motor and batteries and include decorative shrouds which prevent access to more structurally sound parts of the manifold and bottle attachment flange and collar.

### SUMMARY OF THE PRESENT INVENTION

The present invention discloses a compact and portable spray misting fan in which an associated pump cylinder is aligned in close proximity, and typically parallel, to a drive axis associated with a motor driving the fan blades. The pump cylinder is incorporated into a piston-mounted spray orifice.

Cam surfaces associated with the spray nozzle facilitate the pump cylinder following an axially displaceable track during a piston driving stroke, and such as during coacting with an opposing cam surface exhibited upon an actuating trigger. Additional features include modifying an angle of the spray relative to the pump axis to better direct the mist into the fan blades or away from a drinking nipple.

In a first variant, the pump is incorporated into a compact, typically keychain mounted misting fan and by which the fan, pump and reservoir are integrated into a single enclosure. In a further, and slightly enlarged, variant a fan subassembly is separable from the reservoir through a secondary pivot assembly associated with an actuating trigger and a separately located release latch.

In a yet further embodiment, a compact water misting fan with trigger actuating sprayer is separable from a reservoir holding body. A dip tube extends from the fan into the reservoir body for communicating fluid, in vacuum withdrawing fashion, into the head attachment unit.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a sectional view of a component pump incorporated into the portable misting fan of the present assembly and including a uniquely configured actuator button with cam surfaces;

FIG. 2 is a perspective view of a first compact version of a portable misting fan and incorporating the component pump of FIG. 1;

FIG. 3 is a plan view outline of the portable misting fan of FIG. 2 and illustrating the arrangement of the component pump within the misting fan according to the present invention;

FIGS. 4A and 4B illustrate relaxed and spray positions, respectively, associated with the piston actuation pump associated with the portable misting fan illustrated in the embodiment of FIGS. 3 and 4;

FIG. 5A is a first perspective illustration of a secondary version of a portable misting fan with separable fan unit according to the prior art;

FIG. 5B is a second and succeeding perspective illustration and by which a trigger component is rotated to a secondary and disengage position;

FIG. 5C is a third succeeding illustration by which a release latch associated with the fan unit permits the same to be released from the reservoir body;

FIG. 6 is a plan view outline of the prior art portable misting fan of FIGS. 5A-5C and illustrating the arrangement of the component pump within the misting fan according to the present invention;

FIGS. 7A and 7B illustrate succeeding rest and spray actuation positions of misting fan of the prior art in FIG. 6, and with the motor and switch removed for ease of illustration;

FIG. 8 is a plan view outline of a compact portable misting fan according to a further preferred embodiment and which is secured atop a fluid holding container;

FIGS. 9A and 9B are respective rest and actuation illustrations, in plan view outline, of the spray misting fan of FIG. 8 and by which the pump actuator button and arm are combined into a single component;

FIG. 10 is an illustration of a spray misting fan according to a still further preferred embodiment and by which a reservoir is located remotely from a fan and misting component (or Fan'n'Sip handpiece), interconnected by an elongated and flexible tube; and

FIG. 11 is a plan view outline of the fan and misting component of FIG. 10 and again exhibiting an integrally formed, closely positioned and parallel extending pump cylinder relative to a motor shaft axis.

### DETAILED DESCRIPTION OF THE PREFERRED EMBODIMENTS

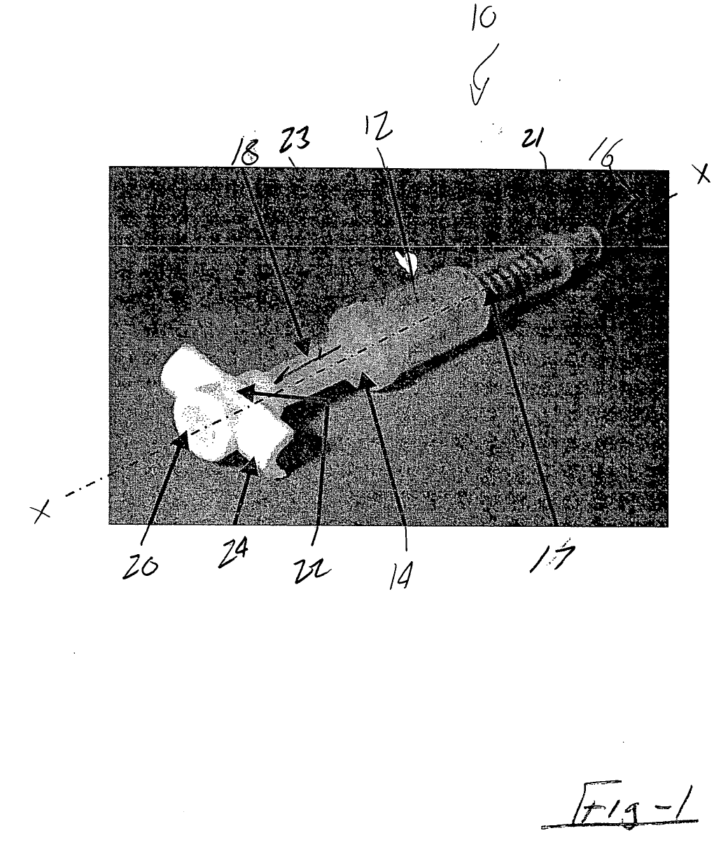

Referring to FIG. 1, a sectional view is illustrated at 10 of a component pump incorporated into the portable misting fan according to the present assembly. An elongated body of the component pump includes such features as a pump cylinder 12, into which is axially displaced a piston 14. A pump inlet 16 is fluidly connected to a reservoir (not shown in this view) and causes a fluid to be withdrawn from the reservoir into the pump cylinder 12 on the outstroke, fluid further being expelled from the pump cylinder upon lateral and inward actuation (instroke) of the pump piston 14.

Upon being actuated, and in a direction referenced by linear axis X extending through an elongated centerline of the pump 10, see also as referenced at 17, the fluid within the cylinder 12 is axially dispelled through a discharge tube 18 and in a direction towards a spray orifice 20 incorporated into a pump actuator button 22. The pump actuator button is directly mounted to the shaft (or discharge tube 18) and provides a channel from the interior of the tube 18 to the orifice 20. When the pressurized water flows through the orifice it is atomized into a spray of fine droplets.

The body 10 further includes a coil spring 21 and which biases the piston 14 and associated discharge tube 18 in a linear direction referenced at 23. The button includes cam surfaces 24 and which, as will be described in greater detail with respect to the succeeding figure descriptions, facilitates the spray dispersion of the fluid.

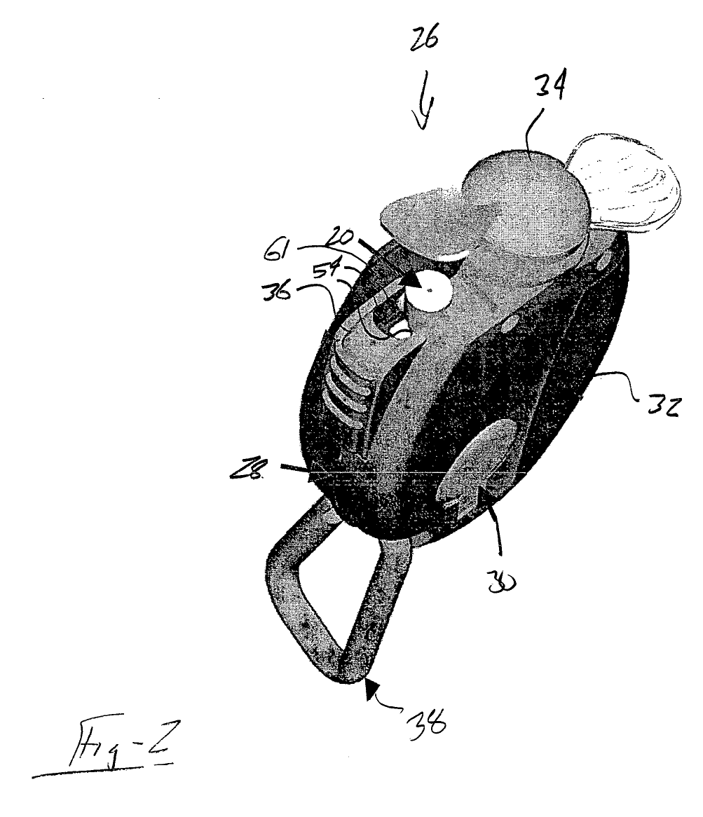

Referring now to FIG. 2, a perspective view is shown at 26 of a first compact, hand-held, version of a portable misting fan and which incorporates the component pump of FIG. 1 (see externally viewable spray orifice 20). The fan 26 incorporates the features of the reservoir and pump into a single and compact enclosure 28.

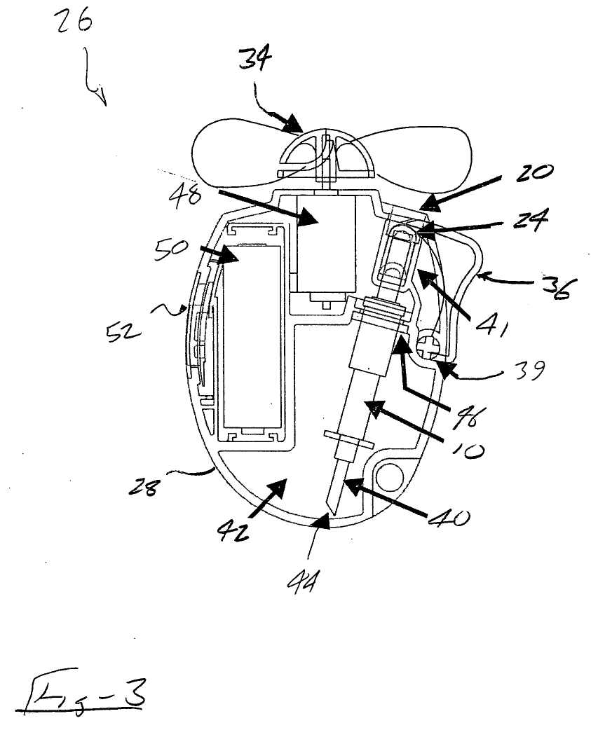

Additional features include a fluid filling reservoir plug 30, a battery cover 32, rotatable fan impeller 34 (including soft foam plastic blades) and actuating trigger 36. The enclosure includes internal partitions to hold fluid/water without leaking and the user removes the reservoir plug 30 to refill with water. Additionally, the user slides outwardly the battery cover 32 to access an associated battery compartment. A carrying clip 38 facilitates suspending of the fan 26 for portability. A pivot is also shown at 39 and a guide at 41 (see again FIG. 3) for the actuator trigger 36. The guides for the “ears” on the sprayer button are fixed to the enclosure, and ensure linear motion and remove side loads from the associated piston and remainder of the pump assembly.

Referring again to FIG. 3, a plan view outline is shown of the portable misting fan 26 of FIG. 2 and better illustrating the arrangement of the component pump 10 within the misting fan according to the present invention. Specifically, a dip tube 40 extends from an end of the pump inlet and communicates within a water filled reservoir 42, see also angled inlet end 44 of dip tube 40. The pump 10 is mounted by an annular grommet 46 and such that the cam surfaces 24 and outlet 20 are arranged in proximity to an exterior location of the pump 10 proximate and in contact with the rotating impeller blades 34.

Additional features of the fan 26 include a motor 48 for rotatably driving the impeller blades 34, the motor in turn being operated by a battery 50 selectively activated and deactivated by switch 52. In this particular variant, a preferred configuration is to position the pump 10 to be located adjacent to the motor 48 and to spray toward the fan blades of the impeller 34 from behind.

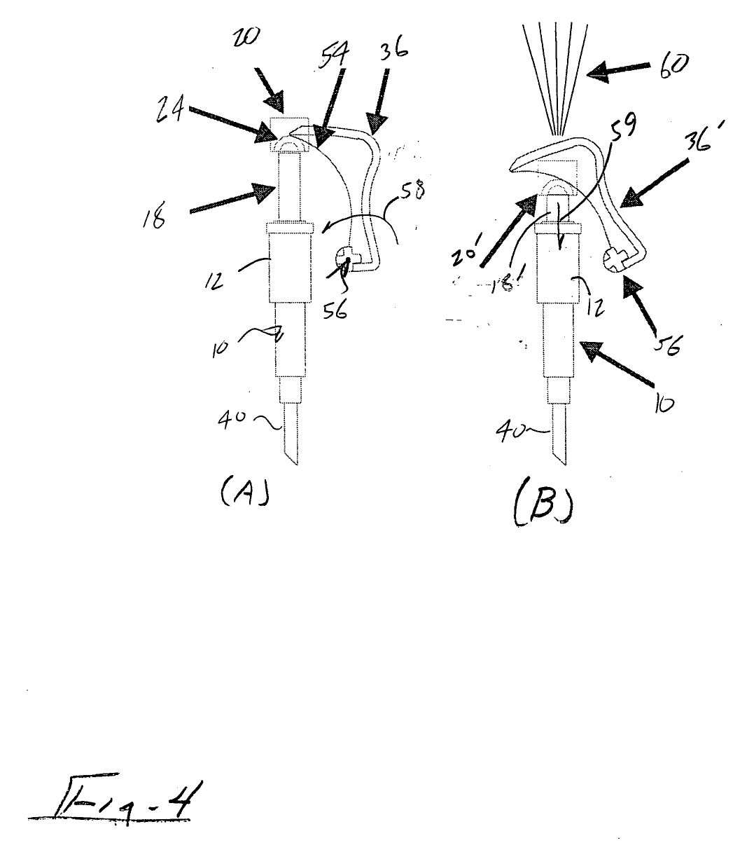

Referring further to FIGS. 4A and 4B, relaxed and spray positions, respectively, are illustrated of the piston actuation pump associated with the portable misting fan illustrated in the embodiment of FIGS. 3 and 4. Specifically, and referencing first FIG. 4A, the sectional illustration of the sprayer is shown in a full-outstroke, resting configuration, and by which cam surfaces 54 associated with the pivotally associated trigger 36 rest against opposing cam surfaces 24 associated with the inwardly/linearly depressible pump 10. Specifically, the trigger 36 is mounted for pivoting about a pin connection 56 associated with the fan body, and as further referenced by arcuate directional arrow 58.

Further referencing FIG. 4B, the trigger is illustrated in a rotated position 36′, and by which the pump actuator discharge tube is likewise inwardly and axially depressed (see at 18′). In this position, the cam surfaces 24 on the pump actuator press against an opposing and half-circle shaped cam surface 54 associated with the inward engaging surface of the pump actuating button (or trigger 36), thus driving it and the pump piston inward (see directional arrow 59) in order to create the spray or mist 60.

In this configuration, a contact point established between the interengaging cam surfaces is off a center line so that there are some side loads (defined as loading vector forces not directed substantially in an axial/center line fashion such as in reference to axis 17 of FIG. 1) on the actuator button 20. Also, some side loads may be created due to friction between the opposing cam surfaces. Referring also to the perspective illustration of FIG. 2, and although not clearly shown, guide tracks 61 are defined in the enclosure keep the actuator button moving in a straight line and so that the discharge tube 18 can depress axially inwardly while the likewise depressing actuator button 20 is retained within the open recessed (“U” shaped) configuration of the trigger 36 top surface while the trigger 36 is being rotated in the fashion illustrated.

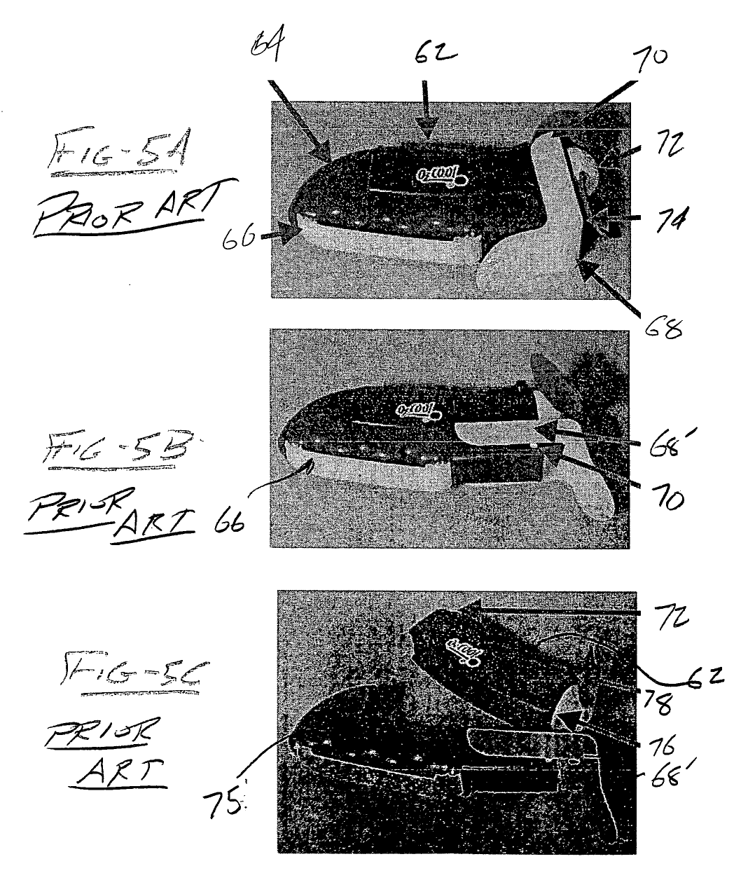

Referring now to FIG. 5A, a first perspective illustration is shown at 62 of a secondary version of a portable misting fan with separable fan unit and which is known in the prior art. Features of this variant include a fluid filled reservoir 64, carrying strap 66, and trigger mechanism 68 secured about a pivot 70. An impeller unit 72 is mounted to the fan 62 in proximity both to the pivot mounted trigger 68 as well as to a spray issuing orifice.

FIG. 5B is a second and succeeding perspective illustration and by which the trigger component is rotated to a secondary and disengage position 68′, such as which reveals a pump actuator button 70. FIG. 5C is a third succeeding illustration, and by which a release latch 72 associated with the fan unit 62 is actuated, permitting the unit 62 to be releasingly disengaged from a main reservoir body 75. A hook 76 and pivot 78 arrangement associated with a forward end of the fan enclosure facilitates rotation and removal of the fan unit 62 from the reservoir body 75.

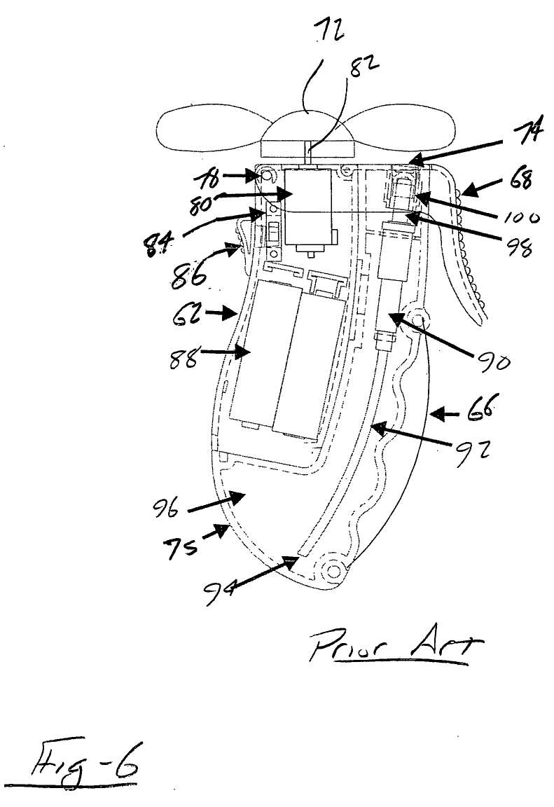

Referring now to FIG. 6, a plan view outline of the portable misting fan of FIGS. 5A-5C is illustrated, and which includes an arrangement of the component pump within the misting fan according to the present invention. Specifically, a motor 80 is arranged in operative and driving fashion relative to the impeller unit 72 (see drive shaft 82 connecting therebetween). A switch 84 for activating the motor 80 is operated by a switch actuator 86, in turn connected to a pair of batteries 88.

A piston pump 90 is mounted within the assembly and includes a dip tube 92, with inlet 94, communicating with a reservoir enclosure 96. The trigger 68 is pivotally arranged relative to the pump 90 and such that a discharge tube 98 is depressed axially inwardly upon the trigger 68 being pivotally actuated. Guide tracks 100 facilitate proper pivotal to axial motion between the trigger and pump. Unlike the prior embodiment, the pivot and actuation pads are located on opposite sides of the pump. This provides the advantage of reducing side loads and friction existing between the cam surfaces.

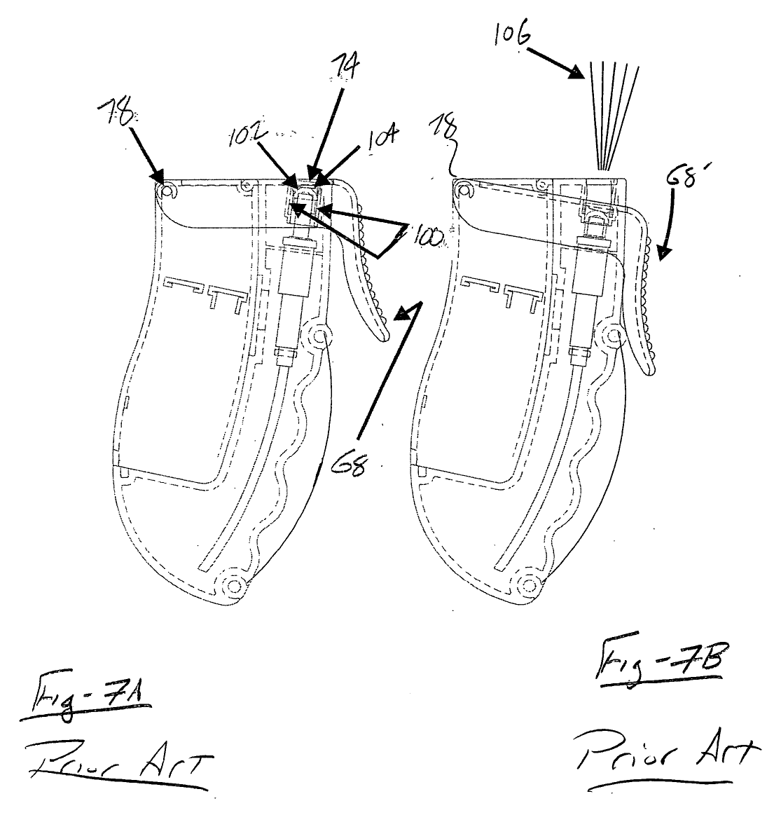

FIGS. 7A and 7B illustrate succeeding rest and spray actuation positions of misting fan of FIG. 6, and with the motor and switch removed for ease of illustration. The motor and switch are removed from these figures for purposes of clarification of illustration. Specifically, FIG. 7A illustrates the pump actuator in a full outstroke condition.

As further shown, opposing cam surfaces associated with the pump actuator button (at 102) are aligned with additional surfaces associated with the pump arm/trigger 68 (at 104). As shown in FIG. 7B, the trigger is rotated to its depressed position 68′, causing the cam surface on the pump actuator arm to push against the pump actuator button, thus driving it inwardly into the associated pump cylinder, and by which a spray mist 106 is issued.

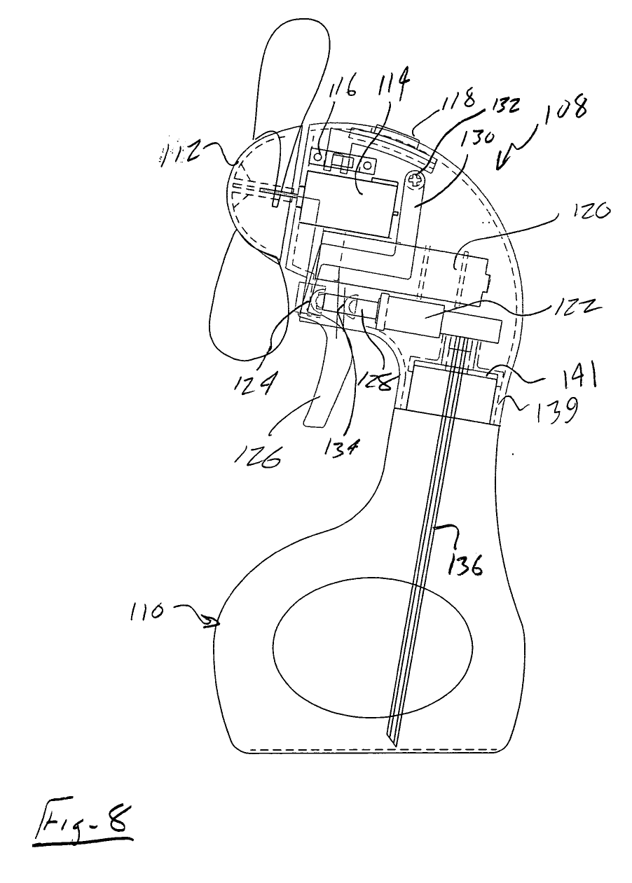

Referring now to FIG. 8, a plan view outline is shown at 108 of a compact portable misting fan according to a further preferred embodiment, and which is secured atop a fluid holding container 110. The unit 108 includes a fan blade impeller unit 112, driven by an electric motor 114 operated by a switch 116 and switch actuator 118. A battery 120 is operatively communicated to the motor 114 dependent upon the position of the switch 116 and actuator 118.

A piston pump 122 is likewise illustrated in line art fashion within the unit 108, and such as that it extends in a linear direction substantially parallel to a centerline of the motor 114. An orifice 124 of the pump 122 is located in proximity to a path of the rotating impeller blades and such that, upon actuating of a trigger 126 extending from the unit, a discharge tube 128 of the pump is actually and inwardly depressed, causing a spray mist to be issued.

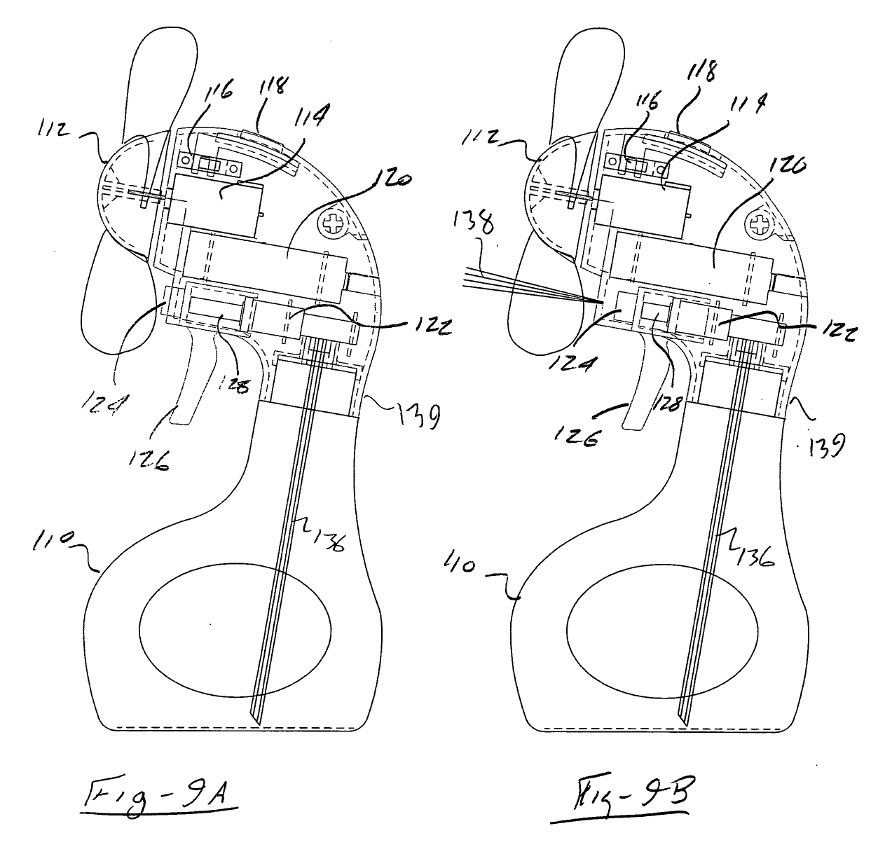

The trigger 126 is further integrally formed with a multi-angular arm 130, pivotally connected at an opposite end 132 with lateral side locations associated with the outer shell of the fan unit. Upon depressing the trigger inwardly, opposing cam surfaces 134 established between the trigger and pump cause the desired inward actuation of the discharge tube and piston within the pump cylinder, in turn causing fluid to be withdrawn from the reservoir, into a dip tube 136 extending downwardly from the pump, and dispensing in a spray mist 138. A screw cap 139 facilitates engagement of the fan unit atop the fluid reservoir bottle and an annular gasket 141 is provided for additional sealing between the bottle reservoir 110 an attachable unit 108. Referring also to FIGS. 9A and 9B, respectively illustrated are rest and actuation illustrations, in plan view outline, of the spray misting fan of FIG. 8 and by which the pump actuator button and arm are combined into a single component.

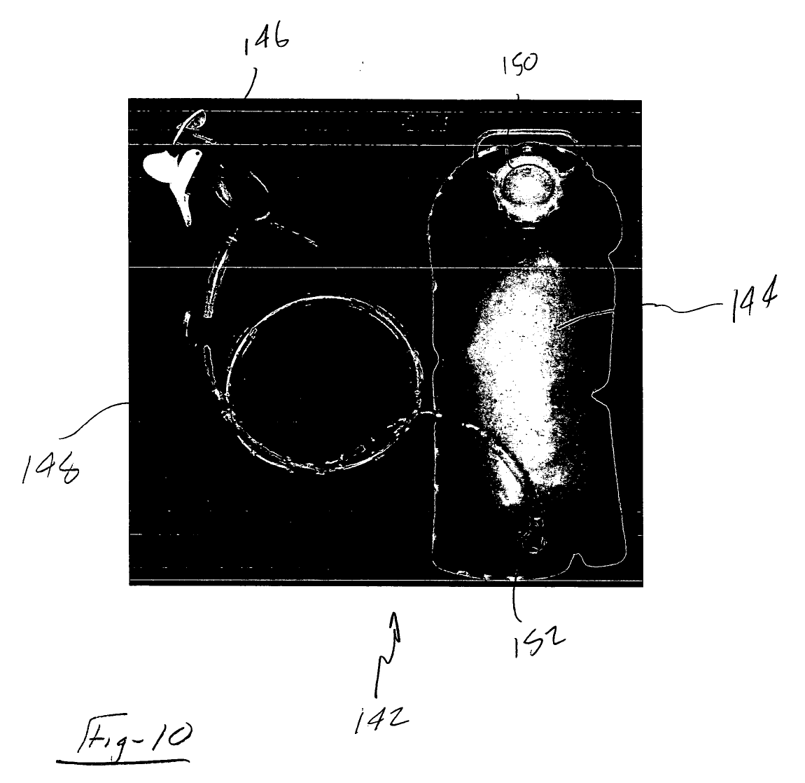

FIG. 10 is an illustration of a spray misting fan according to a still further preferred embodiment 142, and by which a reservoir 144, such as a flexible bladder or container, is located remotely from a fan and misting component 146 (or Fan'n'Sip handpiece), interconnected by an elongated and flexible tube 148. The reservoir bladder 144 includes a screw cap 150 for refilling, as well as a location 152 from which the flexible tube 148 extends.

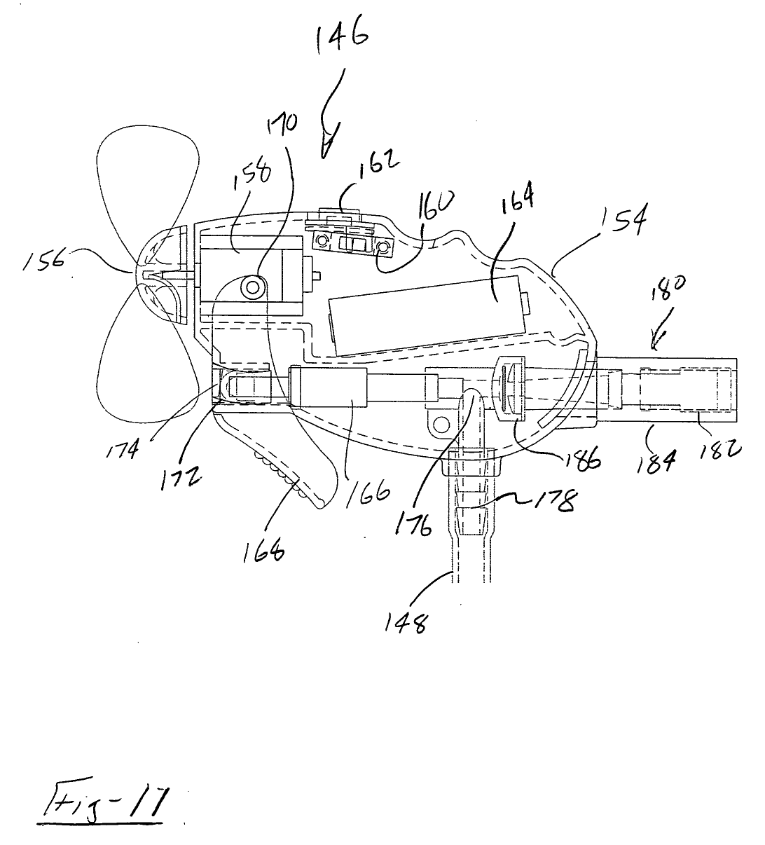

Referring finally, to FIG. 11, a plan view outline is again shown of the fan and misting component 146 of FIG. 10. Features include a durable and plastic body 154, to which is secured an impeller 156. Features common to the previous embodiment also include a motor 158, switch 160, switch actuator 162, and battery compartment 164.

A piston pump 166 is arranged in parallel spaced fashion relative to a centerline extending through the battery 158 and impeller drive shaft. A trigger 168 is pivotally secured at 170 to spaced apart sides of the plastic body 154. The trigger 168 includes an arcuate configuration similar to that illustrated in perspective in the variant of FIG. 2 and such that opposing cam surfaces 172 defined between the trigger and a discharge orifice 174 of the pump 166 coact upon the trigger 168 being pivotally depressed against the pump 166. A manifold 176 is established between the pump 166 and the substantially perpendicularly extending supply tube 178 (see hardened plastic nipple) and in order that fluid is withdrawn from the remote reservoir 144 and through the elongated tube 148.

A drinking nipple assembly is illustrated at 180 and includes a bite valve insert 182 and bite valve sleeve 184, these extending from a check valve 186 (with built in flapper arrangement). The pump inlet is in fluid communication with the manifold 176 which connects the water supply (via tubing) to the drinking nipple 180 and pump. Upon the user biting on the sleeve 184, a channel opens between the insert and sleeve. In a rest position, the bite valve blocks water flow and the check valve 186 prevents backwash, such as of saliva, into the manifold 176.

Having described our invention, other and additional preferred embodiments will become apparent to those skilled in the art to which it pertains and without deviating from the scope of the appended claims.

We claim:

1. A portable misting fan, comprising:
a three-dimensional body;
an impeller including a plurality of rotatable fan blades mounted to said body;
an elongated and linearly actuating pump incorporated into said body, a first end of said pump cylinder defining an inlet in communication with a fluid reservoir, a second end of said pump cylinder defining an exposed orifice in communication with a path of rotation associated with said fan blades, said orifice mounting to a piston axially displaceable relative to an intermediate cylinder portion of said pump; and
a trigger secured to said body, a portion of said trigger including a cam surface arranged in opposing and coacting fashion relative to a cam surface associated with said orifice such that, upon depressing said trigger, said piston is caused to displace inwardly relative to said cylinder portion, a spray mist issuing from said orifice and into a path associated with said rotating fan blades.

2. The portable misting fan as described in claim 1, said pump further comprising an axially extending coil spring biasing said piston in a direction away from said cylinder portion.

3. The portable misting fan as described in claim 1, further comprising a dip tube extending from said inlet end of said linearly actuated pump.

4. The portable misting fan as described in claim 1, further comprising a battery incorporated into said body and electrically communicable to a motor for driving said impeller.

5. The portable misting fan as described in claim 4, further comprising a switch selectively communicating an output of said battery to said motor, a switch actuator selectively activating and deactivating said switch.

6. The portable misting fan as described in claim 1, further comprising a grommet support for mounting said linearly actuating pump in an arrayed fashion within said body.

7. The portable misting fan as described in claim 4, said motor having a specified shape and size and exhibiting an axial centerline associated with an output drive shaft in operative communication with said impeller.

8. The portable misting fan as described in claim 1, said elongated pump exhibiting a specified shape and size and being arranged such that an axial centerline extending through said orifice extends substantially parallel to said centerline associated with said drive shaft and motor.

9. The portable misting fan as described in claim 1, said trigger exhibiting a specified shape and size and including an interiorly recessed enclosure overlying said orifice.

10. The portable misting fan as described in claim 9, further comprising guide tracks extending along inner surfaces of said enclosure and positioning said orifice during coacting of said cam surfaces and inward displacement of said orifice and discharge tube.

11. The portable misting fan as described in claim 1, said body having a specified shape and size and further comprising a fan enclosure disengageable from a mating reservoir enclosure.

12. The portable misting fan as described in claim 1, said body being mounted atop a fluid holding reservoir, a dip tube extending from said inlet end of said pump cylinder, at an angle relative to an axial centerline associated with said pump cylinder, and into said fluid holding reservoir.

13. The portable misting fan as described in claim 12, further comprising a gasket for fluidly sealing an annular opening associated with said body to an open neck associated with said fluid holding reservoir.

14. The portable misting fan as described in claim 1, further comprising a fluid holding reservoir located remotely from said body and interconnected by an elongated and flexible fluid carrying tube.

15. The portable misting fan as described in claim 14, said fluid holding reservoir further comprising a flexible bladder including a cap for refilling, as well as a location from which said flexible tube extends.

16. The portable misting fan as described in claim 14, said body further comprising a bite valve extending from said inlet end of said pump cylinder, in angular and fluidly communicating fashion relative to an inlet associated with said flexible tube, by a manifold disposed therebetween.

17. The portable misting fan as described in claim 16, said bite valve further comprising a flexible bite valve sleeve, a check valve communicating said bite valve sleeve with said fluid inlet and, upon engaging said bite valve, facilitating fluid flow through said sleeve.

18. The portable misting fan as described in claim 1, said body having a specified shape and size and incorporating a fluid holding reservoir.

19. The portable misting fan as described in claim 18, a reservoir plug defined in said body and communicating with said fluid holding reservoir.

20. The portable misting fan as described in claim 18, said body further comprising first and second assembleable halves assembled in a clamshell arrangement by sonic welding to define said reservoir.

21. A portable misting fan, comprising:
a three-dimensional body upon which is mounted an impeller including a plurality of rotatable fan blades;
an elongated and linearly actuating pump mounted in extending fashion within said body, a first end of said pump cylinder defining an inlet in communication with a fluid reservoir defined within said body, a second end of said pump cylinder terminating in an exposed and axially displaceable orifice in communication with a path of rotation associated with said fan blades, said orifice mounting to a discharge portion extending within an intermediate cylinder portion of said pump; and
a trigger pivotally secured to first and second surfaces of said body, cam surfaces associated with said trigger and orifice being arranged in opposing and coacting fashion such that, upon depressing said trigger, said discharge tube is caused to displace inwardly relative to said cylinder portion resulting in a spray mist issuing from said orifice and into a path associated with said rotating fan blades.

22. A portable misting fan, comprising:
a three-dimensional body formed by first and second assembleable halves;
a first reservoir chamber defined in said body, a resealable plug permitting a refilling of said chamber;
at least one additional chamber enclosing a motor, a supplying battery and a spray mechanism communicating with an exteriorly disposed orifice;
a port interconnecting said first reservoir chamber with said spray mister; and
a pump located within said reservoir chamber and which is at least partially immersed in a fluid reservoir, actuation of said pump supplying fluid to said spray mechanism for issuance through said orifice.
